(19) United States
(12) Patent Application Publication
(10) Pub. No.: US 2008/0257680 A1
(43) Pub. Date: Oct. 23, 2008

(54) Wire winder with single pulling end

(76) Inventor: Sung-Chiang Wu, Taipei Hsien (TW)

Correspondence Address: SUNG-CHIANG WU, 235 Chung-Ho, Box 8-24, Taipei, TW

(21) Appl. No.: 11/787,674

(22) Filed: Apr. 18, 2007

(51) Int. Cl. F16D 69/00

(52) U.S. Cl. 192/205

(57) ABSTRACT

A wire winder with single pulling end comprises a lower cover having a shaft at a center portion thereof; the shaft having at least one slot; a smaller protrusion and a larger protrusion being arranged at two outer sides of the slot; each of the smaller protrusion and larger protrusion having a cambered shape; the larger protrusion being larger than the smaller protrusion; and a transmission line installed on the lower cover; one end of the transmission line being fixed to an interior of the shaft; then the transmission line being guided out through the slot of the shaft so that the transmission line resists against one of the larger protrusion and the small protrusion; then the transmission line winding around the shaft of the lower cover for several circles.

### FIELD OF THE INVENTION

The present invention relates to wire winders, and particularly to a wire winder with single pulling end, wherein two protrusions beside a slot of a shaft receiving the transmission line of the wire winder have unequal sizes so that the transmission line has a longer lifetime.

### BACKGROUND OF THE INVENTION

Transmission lines are necessary device for the transmission of electronic signals, especially, USB transmission lines are more important for the current applications. However, it is often that the transmission lines are arranged disorderly. Thus wire winders for transmission lines are developed for receiving transmission lines so that the transmission line can be stored orderly and carried conveniently.

However, the prior art wire winder often makes the transmission line to be destroyed due to the repeatedly receiving and pulling out operations. Referring to FIG. 7, a prior art winder with single one variable end is illustrated. The prior art has a lower cover has a shaft 82 at a center portion thereof. The shaft 82 has at least one slot. Two protrusions are arranged at two outer sides of the slot. A transmission line 7 has one end fixed to an interior of the shaft 82 and another end thereof passes through the slot of the shaft 82 and then is extended out by winding through one of the two protrusion. However, in the prior art, the two protrusions have equal sizes so that whenever in receiving the transmission line 7 into the winder or pulling the transmission line 7 out of the winder, the same point C is in contact with the protrusion. For a long time the transmission line 7 will be cut so as to reduce the lifetime of the transmission line 7.

### SUMMARY OF THE INVENTION

Accordingly, the primary object of the present invention is to provide a wire winder with single pulling end, wherein two protrusions beside a slot of a shaft receiving the transmission line of the wire winder have unequal sizes so that the transmission line has a longer lifetime.

To achieve above objects, the present invention provides a wire winder with single pulling end comprises a lower cover having a shaft at a center portion thereof; the shaft having at least one slot; a smaller protrusion and a larger protrusion being arranged at two outer sides of the slot; each of the smaller protrusion and larger protrusion having a cambered shape; the larger protrusion being larger than the smaller protrusion; and a transmission line installed on the lower cover; one end of the transmission line being fixed to an interior of the shaft; then the transmission line being guided out through the slot of the shaft so that the transmission line resists against one of the larger protrusion and the small protrusion; then the transmission line winding around the shaft of the lower cover for several circles. The present invention further comprises a rotary seat having a round ring which are formed at an upper side of the rotary seat, in the upper side of the rotary seat, an interior of the round edge is formed as a spring groove; in assembly the rotary seat being located above the lower cover; wherein the lower cover having an upper protruded edge for confining an object received therein; the edge has a wire outlet; and wherein the transmission line being installed between the lower cover and the rotary seat; the transmission line being guided out from a slit of a ring, which is fixed to the lower cover; then the transmission line winds around the ring through several circles and then the transmission line leaves the lower cover from the slot. The present invention further comprises a spiral spring installed in the spring groove of the rotary seat; one side of the spiral spring being fixed to the interior of the shaft of the lower cover; a guide seat installed upon the rotary seat with the spiral spring being installed between the guide seat and the rotary seat; the shaft of the lower cover passing through a center hole of the rotary seat to be fixed to the guide seat; an upper side of the guide seat being formed with an annular track and a positioning groove being formed for communicating the annular track and a center groove at the upper side of the guide seat; and a positioning unit being installed in the annular track of the guide seat. Furthermore an upper cover is installed at an upper side of the guide seat; and a lower side of the upper cover having a space for receiving the positioning unit.

The various objects and advantages of the present invention will be more readily understood from the following detailed description when read in conjunction with the appended drawing.

### BRIEF DESCRIPTION OF THE DRAWINGS

FIG. 1 is an assembled view of the wire winder with single pulling end of the present invention.

FIG. 2 is an exploded view of the wire winder with single pulling end of the present invention.

FIG. 3 is a schematic view showing the lower cover of the wire winder with a single pulling end of the present invention.

FIG. 3A is a partial enlarged view showing the protrusions of the present invention.

FIG. 4 is a schematic view showing the wire output operation according to the present invention.

FIG. 4A is a schematic view showing that the transmission line of the present invention is pulled out along a counterclockwise direction.

FIG. 5 is a schematic view showing the wire receiving operation according to the present invention.

FIG. 5A is a schematic view showing that the transmission line of the present invention is received into the winder along a counterclockwise direction.

FIG. 6 is a perspective view about the wire winder with single pulling end of the present invention.

FIG. 7 is a partial schematic view about the prior art wire winder with single pulling end.

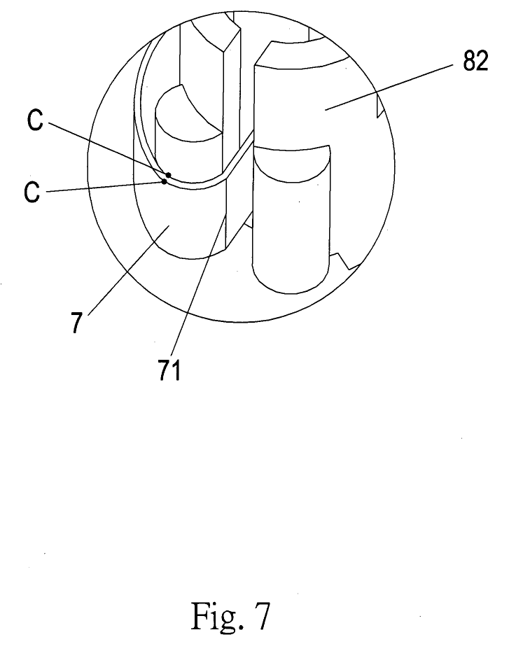

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

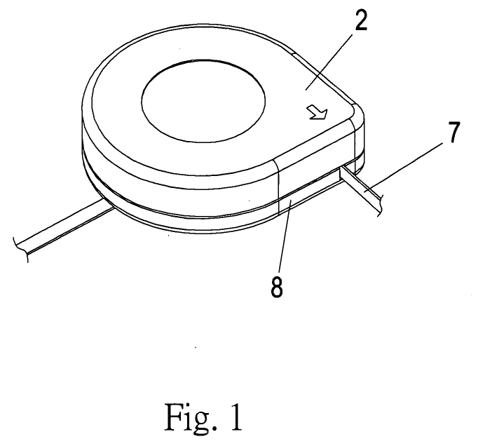

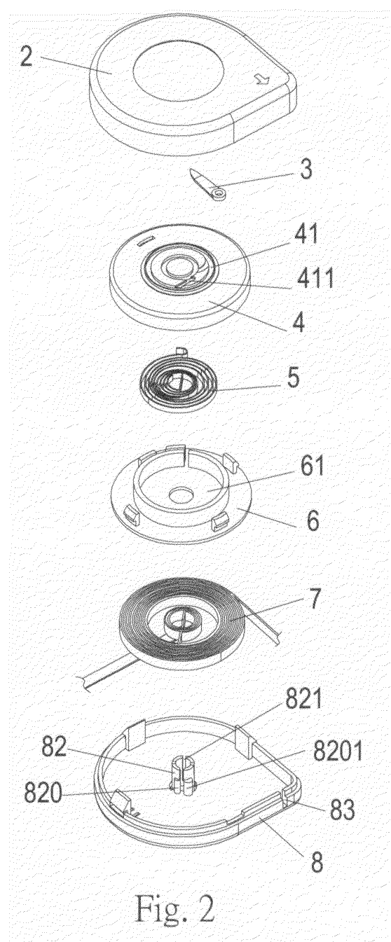

Referring to FIG. 1 and 2, a single curled wire winder according to the present invention is illustrated. The present invention has the following elements.

A lower cover 8 has a shaft 82 at a center portion thereof. The shaft 82 has at least one slot 821. A smaller protrusion 820 and a larger protrusion 8201 are arranged at two outer sides of the slot 821. Each of the smaller protrusion 820 and larger protrusion 8201 has a cambered shape. The larger protrusion 8201 is larger than the smaller protrusion 820. The lower cover 8 has an upper protruded edge for confining an object received therein. The edge has a wire outlet 83.

A rotary seat 6 has a round ring 62 which are formed at an upper side of the rotary seat 6. In the upper side of the rotary seat 6, an interior of the round edge 62 is formed as a spring groove 61. In assembly the rotary seat 6 is located above the lower cover 8.

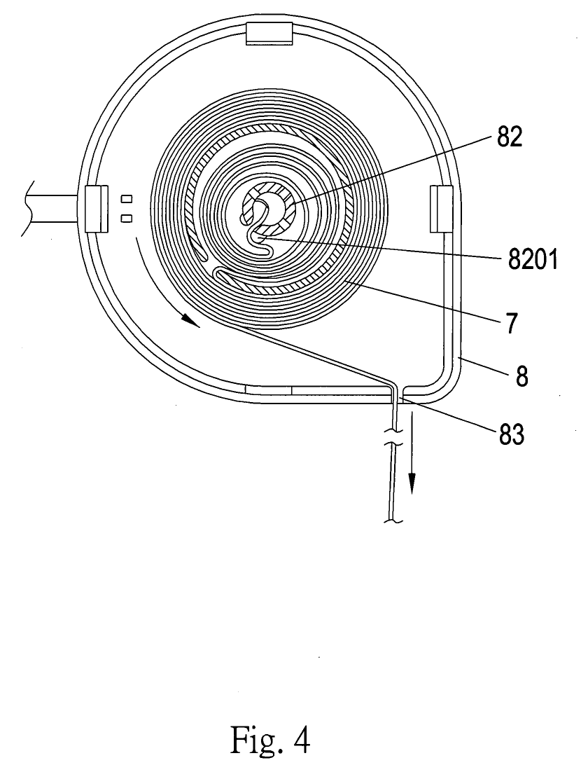

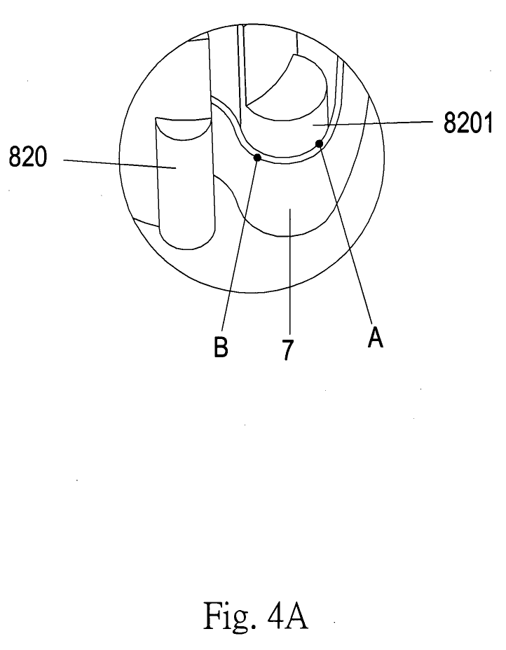

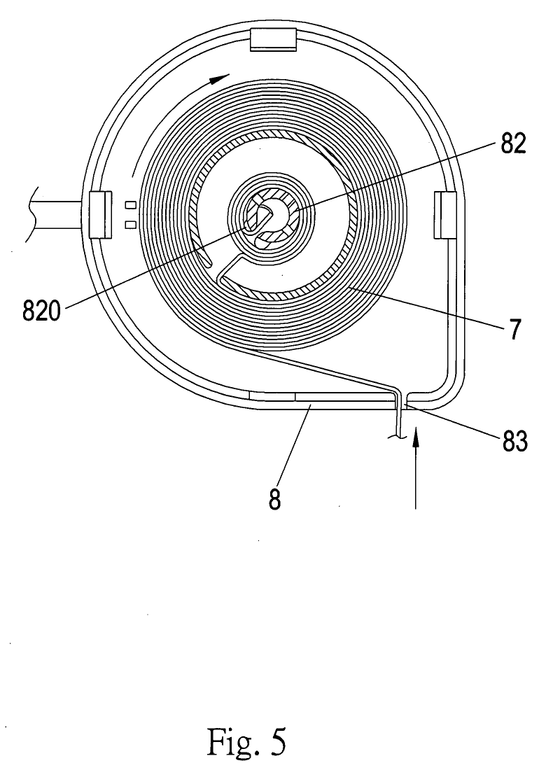

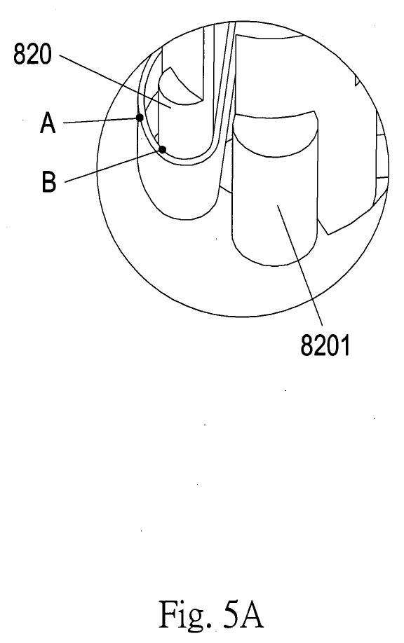

Referring to FIGS. 4 and 5, a transmission line 7 is installed between the lower cover 8 and the rotary seat 6. One end of the transmission line 7 is fixed to an interior of the shaft 82. Then it is guided out through the slot 821 of the shaft 82. Then the transmission line 7 winds around the shaft 82 of the lower cover 8 for several circles. Then the transmission line 7 is guided out from a slit 8221 of a ring 822 which is fixed to the lower cover 8. Then the transmission line 7 winds around the ring 822 through several circles and then the transmission line 7 leaves the lower cover 8 from the slot 821.

A spiral spring 5 is installed in the spring groove 61 of the rotary seat 6. One side of the spiral spring 5 is fixed to the interior of the shaft 82 of the lower cover 8.

A guide seat 4 is installed upon the rotary seat 6 with the spiral spring 5 being installed between the guide seat 4 and the rotary seat 6. The shaft 82 of the lower cover 8 passes through a center hole of the rotary seat 6 to be fixed to the guide seat 4. An upper side of the guide seat 4 is formed with an annular track 41 and a positioning groove 411 is formed for communicating the annular track 41 and a center groove at the upper side of the guide seat 4.

A positioning unit 3 is installed in the annular track 41 of the guide seat 4.

An upper cover 2 is installed at an upper side of the guide seat 4. A lower side of the upper cover 2 has a space for receiving the positioning unit 3.

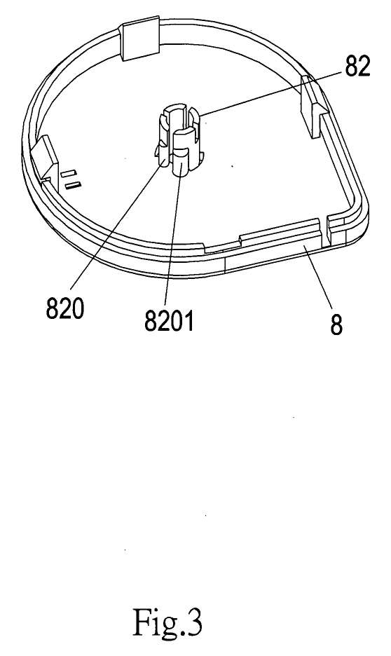

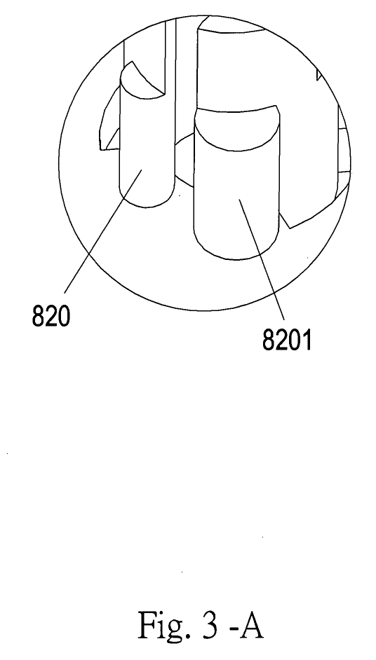

Referring to FIGS. 3 and 3A, after the transmission line 7 leaves the slot 821 of the lower cover 8, the transmission line 7 will resist against one of the smaller protrusion 820 or larger protrusion 8201 which has cambered shape so that the transmission line 7 will not cut by edges of the slot 821.

Referring to FIGS. 4 and 4A, it illustrates the pulling state of the wire winder of the present invention. As the transmission line 7 is pulled out from the winder, the transmission line 7 will resist against the larger protrusion 8201. There are two force applied points A, and B.

Referring to FIGS. 5 and 5A, it illustrates the receiving state of the wire winder of the present invention. As the transmission line 7 is received into the lower cover 8, the transmission line 7 will resist against the smaller protrusion 820. Only point B is in contact with the shaft 82. Thus from those shown in FIGS. 4, 4A, 5 and 5A, it is illustrated that in the receiving state and pulling state of the transmission line 7, the force applied points of the transmission line 7 are not identical so that the lifetime of the transmission line 7 is prolonged.

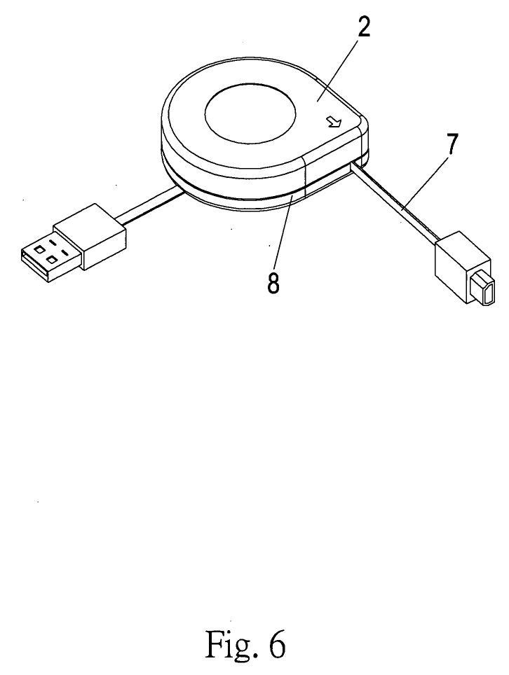

As shown in FIG. 6, the assembly view of the present invention is illustrated. The transmission line 7 has two ends. One has a fixed length and one has a variable length so that it can be used for various electronic devices.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A wire winder with single pulling end, comprising:
a lower cover having a shaft at a center portion thereof; the shaft having at least one slot; a smaller protrusion and a larger protrusion being arranged at two outer sides of the slot; each of the smaller protrusion and larger protrusion having a cambered shape; the larger protrusion being larger than the smaller protrusion; and
a transmission line installed on the lower cover; one end of the transmission line being fixed to an interior of the shaft; then the transmission line being guided out through the slot of the shaft so that the transmission line resists against one of the larger protrusion and the small protrusion; then the transmission line winding around the shaft of the lower cover for several circles.

2. The wire winder with single pulling end as claimed in claim 1, further comprising
a rotary seat having a round ring which are formed at an upper side of the rotary seat, in the upper side of the rotary seat, an interior of the round edge is formed as a spring groove; in assembly the rotary seat being located above the lower cover;
wherein the lower cover having an upper protruded edge for confining an object received therein; the edge has a wire outlet; and
wherein the transmission line being installed between the lower cover and the rotary seat; the transmission line being guided out from a slit of a ring, which is fixed to the lower cover; then the transmission line winds around the ring through several circles and then the transmission line leaves the lower cover from the slot.

3. The wire winder with single pulling end as claimed in claim 2, further comprising:
a spiral spring installed in the spring groove of the rotary seat; one side of the spiral spring being fixed to the interior of the shaft of the lower cover;
a guide seat installed upon the rotary seat with the spiral spring being installed between the guide seat and the rotary seat; the shaft of the lower cover passing through a center hole of the rotary seat to be fixed to the guide seat; an upper side of the guide seat being formed with an annular track and a positioning groove being formed for communicating the annular track and a center groove at the upper side of the guide seat; and
a positioning unit being installed in the annular track of the guide seat.

4. The wire winder with single pulling end as claimed in claim 3, wherein an upper cover being installed at an upper side of the guide seat; a lower side of the upper cover having a space for receiving the positioning unit.
